(19) United States
(12) Patent Application Publication
(10) Pub. No.: US 2012/0158649 A1
(43) Pub. Date: Jun. 21, 2012

(54) ELECTRONIC DEVICE AND METHOD OF PREVENTING DELETION OF FILE

(75) Inventor: Juang-hwan CHOI, Suwon-si (KR)

(73) Assignee: Samsung Electronics Co., Ltd., Suwon-si (KR)

(21) Appl. No.: 13/268,240

(22) Filed: Oct. 7, 2011

(30) Foreign Application Priority Data
Dec. 15, 2010 (KR) 2010-0128582

(51) Int. Cl. G06F 7/00

(52) U.S. Cl. 707/609; 707/E17.01; 707/E17.044

(57) ABSTRACT

An electronic device and a method of preventing a deletion of a file are provided. If a deletion command is input from a computer with respect to at least one file stored on a storage unit, the electronic device determines whether the corresponding file is to be deleted by referring to a deletion prevention area. Accordingly, the electronic device maintains a deletion prevention function even when the deletion command is input from the computer.

### CROSS-REFERENCE TO RELATED APPLICATIONS

This application claims the benefit of priority under 35 U.S.C. §119 from Korean Patent Application No. 10-2010-0128582, filed on Dec. 15, 2010, in the Korean Intellectual Property Office, the disclosure of which is incorporated herein by reference in its entirety.

### BACKGROUND OF THE INVENTION

1. Field of the Invention

The present general inventive concept generally relates to an electronic device and a method of preventing a deletion of a file, and more particularly, to an electronic device which can prevent a deletion of a deletion-prevented file when being connected to a computer, and a method of preventing a deletion of a file.

2. Description of the Related Art

If a digital camera or a camcorder captures a picture or a moving picture, the captured picture or moving picture is stored as a file on a storage medium of the digital camera or the camcorder. Also, a user sets deletion prevention with respect to each file to prevent deletion of the file by mistake. Therefore, the user prevents an important file from being deleted by the digital camera.

If the digital camera is connected to the computer through a universal serial bus (USB), the user checks files stored on the storage medium of the digital camera through a monitor of the computer. Also, the user copies, moves, and deletes the files stored on the storage medium of the digital camera, using the computer.

However, if the user inputs deletion commands with respect to the file stored on the storage medium of the digital camera through the computer, although deletion preventions are set with respect to the files in the digital camera, the files are deleted. This is because the deletion prevents are set to be recognized only in the digital camera, but any setups are not made with respect to a case where a deletion command is input into the computer.

Accordingly, a method of preventing deletion of a file having deletion-protection settings set in a digital camera is required.

### SUMMARY OF THE INVENTION

The present general inventive concept provides an electronic device which, if a deletion command is input from a computer to the electronic device with respect to at least one file stored on a storage unit, determines, using a deletion prevention area, whether the file is to be deleted, and a method of preventing the deletion of the file.

Additional embodiments of the present general inventive concept will be set forth in part in the description which follows and, in part, will be obvious from the description, or may be learned by practice of the general inventive concept.

The foregoing and/or other features and utilities of the present general inventive concept may be achieved by an electronic device, including an interface unit to be connected to a computer, a storage unit to store files using a file allocation table (FAT) file system comprising a deletion prevention area, and a controller to determine using the deletion prevention area whether a file is to be deleted when a deletion command is input via the computer with respect to the file which is a file stored on the storage unit.

The deletion prevention area may be an additional deletion prevention FAT area.

Sector information, which is a deletion prevention target, may be recorded in the additional deletion prevention FAT area.

If a deletion command is input via the computer with respect to the file stored on the storage unit, the controller may receive from the computer a FAT from which pieces of sector information of a deletion target file have been removed.

If at least one of the pieces of sector information recorded in the additional deletion prevention FAT area is not included in the received FAT, the controller may not execute the deletion command.

If all of the pieces of sector information recorded in the additional deletion prevention FAT area are included in the received FAT, the controller may record the received FAT in a FAT area of the FAT file system to execute the deletion command.

The deletion prevention area may be an additional root directory area.

A file name, which is a deletion prevention target, may be recorded in the deletion prevention area.

If a deletion command is input with respect to at least one of the files stored on the storage unit through the computer, the controller may receive from the computer a root directory entry from which a file name of a deletion target file has been removed.

If at least one of file names recorded in the deletion prevention area is not included in the received root directory entry, the controller may not execute the deletion command.

If all of the file names recorded in the deletion prevention area are included in the received root directory entry, the controller may record the received root directory entry in a root directory area of the FAT file system to execute the deletion command.

The foregoing and/or other features and utilities of the present general inventive concept may also be achieved by a method of preventing a deletion of a file of an electronic device connected to a computer, the method including connecting the electronic device to the computer through an interface, storing files using a FAT file system comprising a deletion prevention area, and if a deletion command is input via the computer with respect to at least one of the stored files through the computer, determining whether the corresponding file is to be deleted, using the deletion prevention area.

The deletion prevention area may be an additional deletion prevention FAT area.

Sector information, which is a deletion prevention target, may be recorded in the additional deletion prevention FAT area.

The determination as to whether the corresponding file is to be deleted may include receiving from the computer a FAT from which pieces of sector information of a deletion target file have been removed, if a deletion command is input via the computer with respect to at least one of the stored files.

The determination may include determining that the deletion command is not executed if at least one of the pieces of sector information recorded in the additional deletion prevention FAT area is not included in the received FAT.

The determination may include recording the received FAT in a FAT area of the FAT file system to execute the deletion command if all of the pieces of sector information recorded in the additional deletion prevention FAT area are included in the received FAT.

The deletion prevention area may be an additional root directory area.

A file name, which is a deletion prevention target, may be recorded in the deletion prevention area.

The determination may include receiving from the computer a root directory entry from which a file name of a deletion target file has been removed, if a deletion command is input via the computer with respect to at least one of the stored files.

The determination may include determining that the deletion command is not executed if at least one of file names recorded in the deletion prevention area is not included in the received root directory entry.

The determination may include recording the received root directory entry in a root directory area of the FAT file system to execute the deletion command if all of the file names recorded in the deletion prevention area are included in the received root directory entry.

As described above, according to various exemplary embodiments, if a deletion command is input via a computer with respect to at least one of files stored on a storage unit, an electronic device determines whether the corresponding file is to be deleted, using a deletion prevention area, and a method of preventing a deletion of a file is provided. Accordingly, the electronic device maintains a deletion prevention function although a deletion command is input from the computer.

Features and/or utilities of the present general inventive concept may also be realized by an electronic device connected to a computer including a storage unit to store a file and including a deletion prevention area and a controller to receive from the computer a deletion command with respect to the file and to determine whether to delete the file based on whether data corresponding to the file is located in the deletion prevention area.

The storage unit may stores files using a file allocation table (FAT) file system, and the deletion command from the computer may be a FAT having sector information omitted that corresponds to the file to be deleted.

The controller may determine to not delete the file when the omitted sector information corresponds to a file listed in the deletion prevention area, and the controller may determine to delete the file when the omitted sector information does not correspond to a file listed in the deletion prevention area.

The deletion prevention area may be a root directory area, and the deletion command from the computer may be a root directory entry from which a file name of the file to be deleted is omitted.

The controller may determine to not delete the file when the omitted file name corresponds to a file listed in the deletion prevention area, and the controller may determine to delete the file when the omitted file name does not correspond to a file listed in the deletion prevention are.

The electronic device may be a camera, and the file may be an image file corresponding to an image captured by the camera.

Features and/or utilities of the present general inventive concept may also be realized by an electronic system, including a host computer and an electronic device connected to the host computer, the electronic device including a storage unit to store a file and including a deletion prevention area, and a controller to receive from the host computer a deletion command with respect to the file and to determine whether to delete the file based on whether data corresponding to the file is located in the deletion prevention area.

Features and/or utilities of the present general inventive concept may also be realized by a method of controlling deletion of a file stored in an electronic device connected to a host computer, the method comprising including receiving from the host computer a deletion command with respect to a file stored in the electronic device, determining whether a deletion prevention setting is set in the electronic device with respect to the file, and deleting the file when the deletion prevention setting is not set, and not deleting the file when the deletion prevention setting is set.

Receiving the deletion command may include receiving a file allocation table (FAT) having sector information omitted that corresponds to the file to be deleted.

Determining whether a deletion prevention setting is set with respect to the file may include comparing the received FAT with a deletion prevention FAT, and determining that the deletion prevention setting is set with respect to the file when the omitted sector information corresponds to sector information listed in the deletion prevention FAT.

Receiving the deletion command may include receiving a root directory entry from which a file name of the file to be deleted is omitted.

Determining whether a deletion prevention setting is set with respect to the file may include comparing the received root directory entry with a deletion prevention root directory area and determining that the deletion prevention setting is set with respect to the file when the file name omitted from the root directory entry received from the computer is included in the deletion prevention root directory area.

### BRIEF DESCRIPTION OF THE DRAWINGS

These and/or other embodiments of the present general inventive concept will become apparent and more readily appreciated from the following description of the embodiments, taken in conjunction with the accompanying drawings of which:

FIG. 1 is a view illustrating a connection state between a camera and a computer according to an exemplary embodiment;

FIG. 2 is a block diagram illustrating a structure of a camera according to an exemplary embodiment;

FIG. 3A is a flowchart illustrating a method of setting deletion prevention with respect to a specific file using a file allocation table (FAT), according to an exemplary embodiment;

FIG. 3B is a flowchart illustrating a process of preventing a deletion of a file for which deletion prevention has been set, using a FAT, according to an exemplary embodiment;

FIG. 4A is a flowchart illustrating a method of setting deletion prevention with respect to a specific file using a root directory according to an exemplary embodiment;

FIG. 4B is a flowchart illustrating a process of preventing a deletion of a deletion-prevented file using a root directory, according to an exemplary embodiment;

FIG. 5A is a view illustrating a structure of a FAT file system according to an exemplary embodiment;

FIG. 5B is a view illustrating a structure of a root directory area according to an exemplary embodiment;

FIG. 5C is a view illustrating a structure of a FAT area according to an exemplary embodiment;

FIG. 6A is a view illustrating a copy prevention FAT area in which copy prevention is set with respect to file “bbb.jpg,” according to an exemplary embodiment;

FIG. 6B is a view illustrating a copy prevention FAT area in which copy prevention is set with respect to file “aaa.jpg,” according to an exemplary embodiment;

FIG. 7A is a view illustrating a root directory type copy prevention area in which copy prevention is set with respect to file “bbb.jpg,” according to an exemplary embodiment;

FIG. 7B is a view illustrating a root directory type copy prevention area in which copy prevention is set with respect o file “aaa.jpg,” according to an exemplary embodiment;

FIG. 8A is a view illustrating a FAT which is generated by a computer to delete file “aaa.jpg,” according to an exemplary embodiment;

FIG. 8B is a view illustrating a FAT which is generated by a computer to delete file “bbb.jpg,” according to an exemplary embodiment;

FIG. 9A is a view illustrating a root directory entry which is generated by a computer to delete file “aaa.jpg,” according to an exemplary embodiment;

FIG. 9B is a view illustrating a root directory entry which is generated by a computer to delete file “bbb.jpg,” according to an exemplary embodiment;

FIG. 10A is a view illustrating a state of file “aaa.jpg” for which deletion prevention has been set, according to an exemplary embodiment;

FIG. 10B is a view illustrating a case where a deletion command is input with respect to file “aaa.jpg,” according to an exemplary embodiment; and

FIG. 100 is a view illustrating a case whether a deletion command is input with respect to file “bbb.jpg,” according to an exemplary embodiment.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

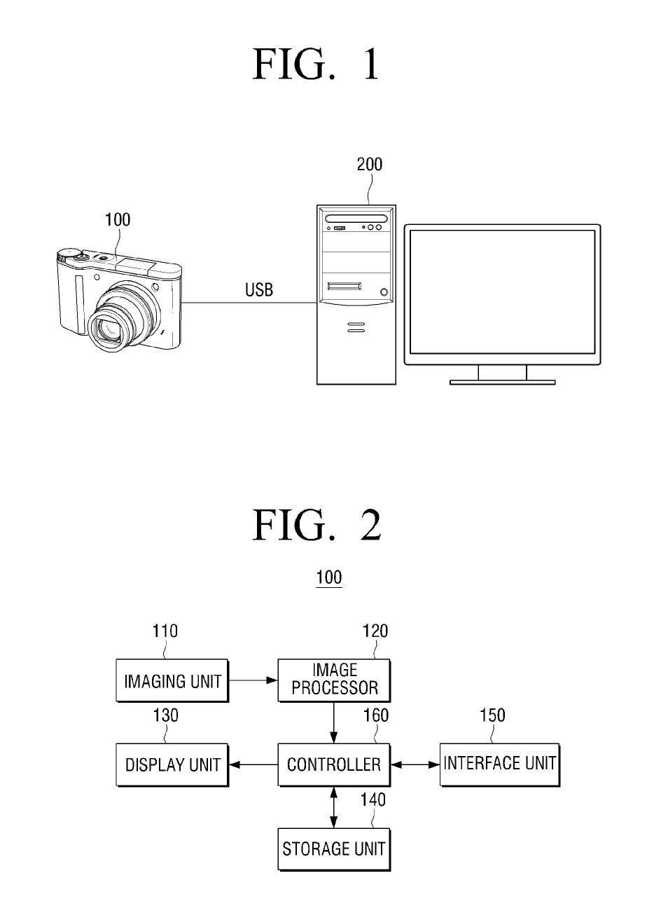

FIG. 1 is a view illustrating a connection state between a camera 100 and a computer 200 according to an exemplary embodiment.

Referring to FIG. 1, the camera 100 is connected to the computer 200 through a universal serial bus (USB) interface. In this state, the computer 200 recognizes files, which are stored in the camera 100, using a USB mass storage (UMS). The computer 200 also controls the files stored in the camera 100 using the UMS. The computer 200 may be, for example, a personal computer, laptop, tablet computer, or other host device including an input device, such as keyboard and mouse, touchscreen, or other input device to control operation of the computer 200 and any devices connected to the computer 200. The camera 100 is a personal camera, or a device including a camera, which, when connected to the computer 200, is capable of downloading content to the computer 200 to be viewed on the computer 200.

Here, the camera 100 sets deletion preventions with respect to the stored files. The camera 100 additionally includes a deletion prevention area in a storage area and records information about deletion-prevented files in the deletion prevention area. The camera 100 also determines whether a file for which a deletion command has been input by the computer 200 is to be deleted, using the deletion prevention area.

Therefore, although the computer 200 inputs a deletion command with respect to a file for which deletion prevention has been set by the camera 100, the camera 100 prevents a deletion of the file.

A structure of the camera 100 will now be described in more detail with reference to FIG. 2. FIG. 2 is a block diagram illustrating a structure of the camera 100, according to an exemplary embodiment. The camera 100 includes an imaging unit 110, an image processor 120, a display unit 130, a storage unit 140, an interface unit 150, and a controller 160.

The imaging unit 110 converts light incident through a lens into an electric signal and performs predetermined signal processing with respect to the electric signal. The image unit 110 performing the above-described functions includes pixels and an analog-to-digital converter (ADC). The pixels respectively output analog image signals, and the ADC converts the analog image signals into digital image signals and outputs the digital image signals.

The image processor 120 performs signal processing with respect to an image input from the imaging unit 110. In more detail, the image processor 120 performs digital zoom, auto white balance (AWB), auto focus (AF), auto exposure (AE), etc. for adjusting format transformation and image scale, with respect to an image signal output from the imaging unit 110.

The display unit 130 displays a captured image or a stored image. The display unit 130 also displays a list of files, which are stored on the storage unit 140, on a screen. The display unit 130 may be, for example, an LCD display unit built into the camera 100.

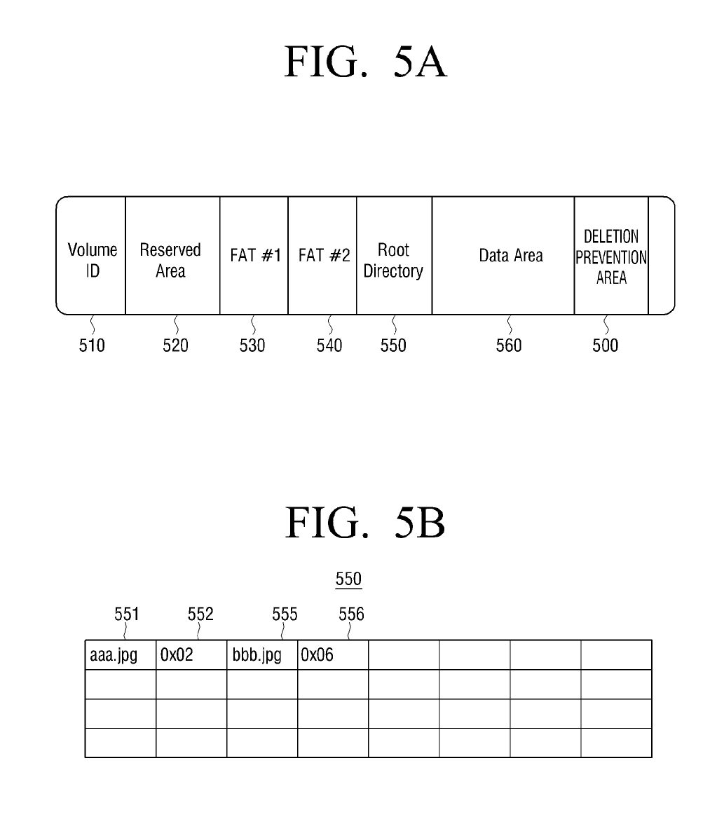

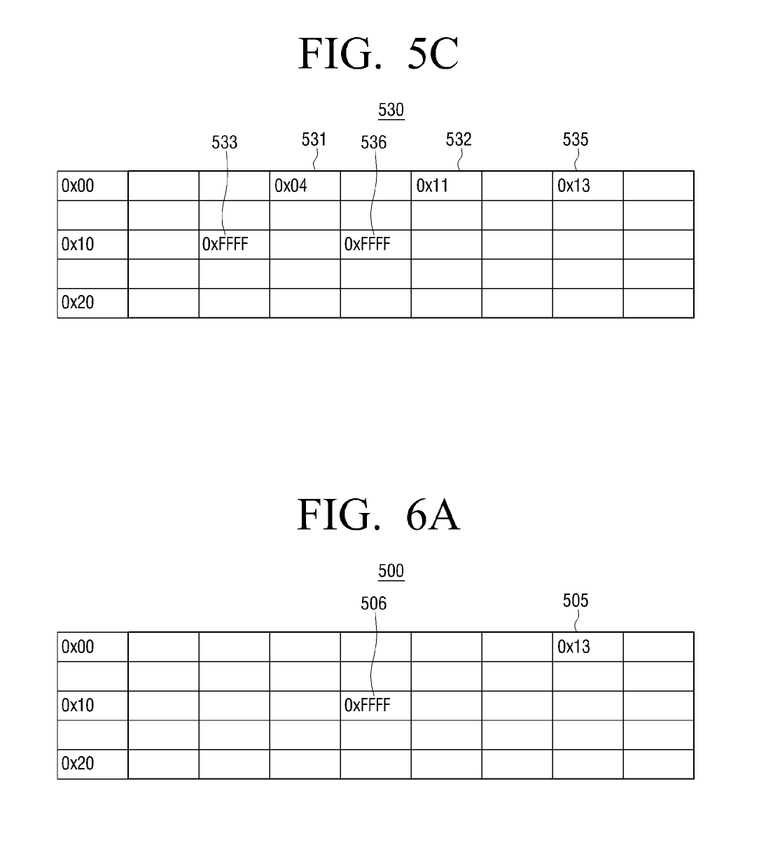

The storage unit 140 stores files of captured images. The storage unit 140 stores the files using a file allocation table (FAT) file system including a deletion prevention area. Here, the FAT file system also includes a FAT 32 file system. A basic structure of the FAT file system will be described later with reference to FIGS. 5A through 5C. The storage unit 140 may include memory such as flash memory, a hard disk, or any other type of memory capable of storing images, tables, and other data in the camera 100.

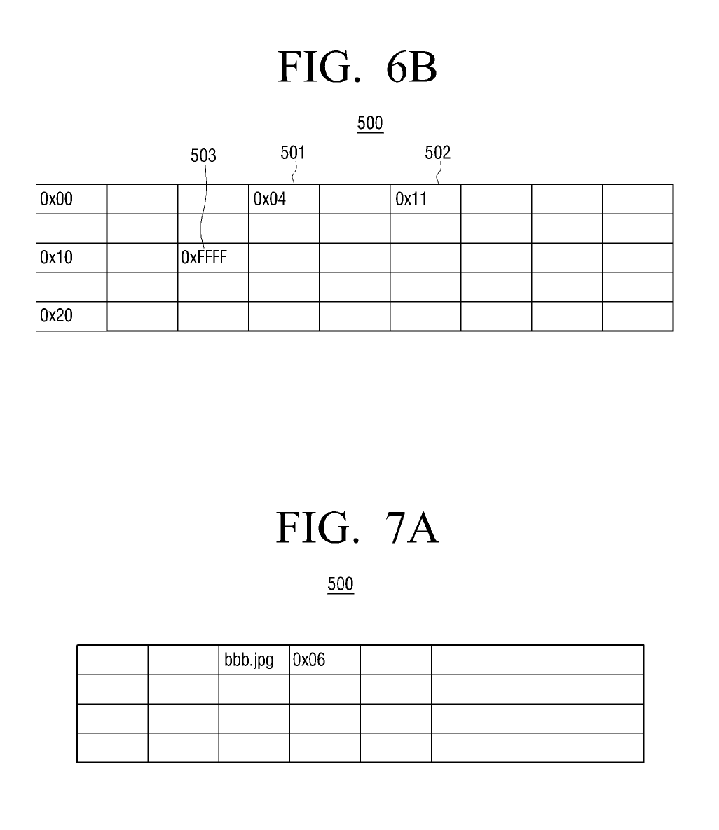

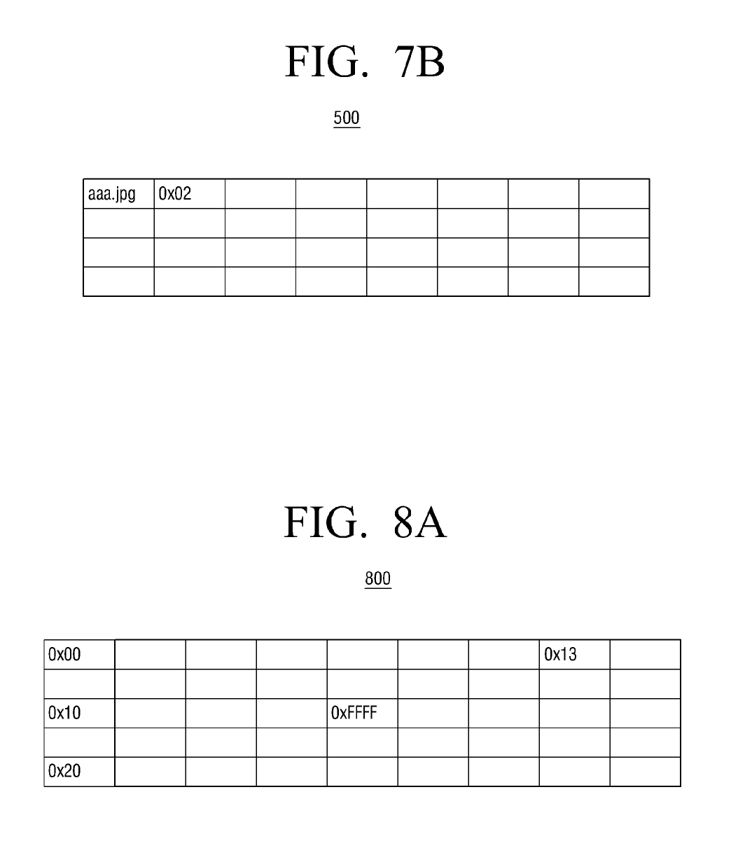

The deletion prevention area refers to an area in the storage unit 140 in which information about deletion-prevented files of the files stored on the storage unit 140 is recorded. Therefore, the files included in the deletion prevention area are files for which deletion prevention settings have been set. The deletion prevention area may be realized as a root directory type or a FAT type, for example. The deletion prevention area is also a partial area of a data area. In other words, as described below in additional detail with respect to a FAT file system of FIG. 5A, a data area may include areas 500 and 560, and the deletion prevention area may include the portion 500 of the data area. The deletion prevention area (or a copy prevention area) will be described later with reference to FIGS. 6A through 7B.

The interface unit 150 connects the camera 100 to the computer 200. In more detail, the interface unit 150 may be a USB. Other examples of an interface unit 150 may include a wireless antenna and supporting circuitry, or any other type of wired connection port. The interface unit 150 transmits and receives a command to control the files stored in the camera 100.

The controller 160 controls an overall operation of the camera 100. In more detail, if a deletion command is input via the computer 200 with respect to at least one of the files stored on the storage unit 140, the controller 160 determines whether the corresponding file is to be deleted, using the deletion prevention area.

Here, the deletion prevention area may be an additional deletion prevention FAT area or an additional root directory area.

If the deletion prevention area is the additional deletion prevention FAT area, the controller 160 records sector information, which is a deletion-prevented target, in the additional deletion prevention FAT area. The additional deletion prevention FAT area is illustrated in FIGS. 6A and 6B.

In more detail, if a deletion command is input via the computer 200 with respect to at least one of the files stored on the storage unit 140, the controller 160 receives a FAT from which pieces of sector information of a deletion target file have been removed, along with the deletion command from the computer 200. The reception of the FAT along with the deletion command is to overwrite the FAT in a FAT area of the FAT file system of the storage unit 140 in order to execute a deletion command with respect to the deletion target file.

If at least one of the pieces of sector information recorded in the deletion prevention FAT area is not included in the received FAT, the controller 160 does not execute the deletion command. This is because the case where the at least one of the pieces of sector information recorded in the deletion prevention FAT area is not included in the received FAT corresponds to a case where a deletion command has been input with respect to a deletion-prevented file. Therefore, in this case, the controller 160 does not delete the deletion target file, generates an error message, and transmits the error message to the computer 200.

If all of the pieces of sector information recorded in the deletion prevention FAT area are included in the received FAT, the controller 160 records (overwrites) the received FAT in the FAT area of the FAT file system to execute the deletion command. This is because the case where all of the pieces of sector information recorded in the deletion prevention FAT area are included in the received FAT corresponds to a case where a deletion command has been input with respect to file for which deletion prevention has not been set. Therefore, the controller 160 deletes the deletion target file.

If the deletion prevention area is the root directory area, the controller 160 records file name information of a deletion-prevented file in the deletion prevention area. This root directory type deletion prevention area is illustrated in FIGS. 7A and 7B.

In more detail, if a deletion command is input with respect to at least one of the files stored on the storage unit 140 through the computer 200, the controller 160 receives a root directory entry from which pieces of file name information of a deletion target file have been removed, along with the deletion command from the computer 200. The reception of the root directory entry along with the deletion command is to overwrite the root directory entry in a root directory area of the FAT file system of the storage unit 140 to execute the deletion command with respect to the deletion target file.

If at least one of the pieces of file name information recorded in the deletion prevention area is not included in the received root directory entry, the controller 160 does not execute the deletion command. This is because when the at least one of the pieces of file name formation recorded in the deletion prevention area is not included in the received root directory entry, a deletion command has been input with respect to a deletion-prevented file. Therefore, the controller 160 does not delete the deletion target file, the controller 160 generates an error message, and the controller 160 transmits the error message to the computer 200.

If all of the pieces of file name information recorded in the deletion prevention area are included in the received root directory entry, the controller 160 records (overwrites) the received root directory entry in the root directory area of the FAT file system to execute the deletion command. This is because when all of the pieces of file name information recorded in the deletion prevention area are included in the received root directory entry, a deletion command has been input with respect to a file for which deletion prevention has not been set. Therefore, the controller 160 deletes the deletion target file.

The camera 100 having the above-described structure prevents a deletion-prevented file from being deleted by the computer 200.

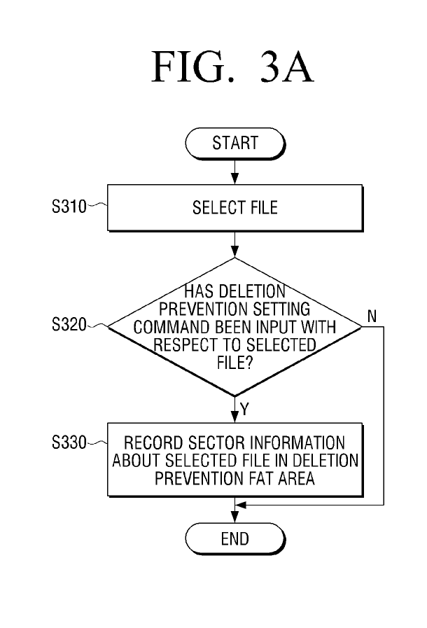

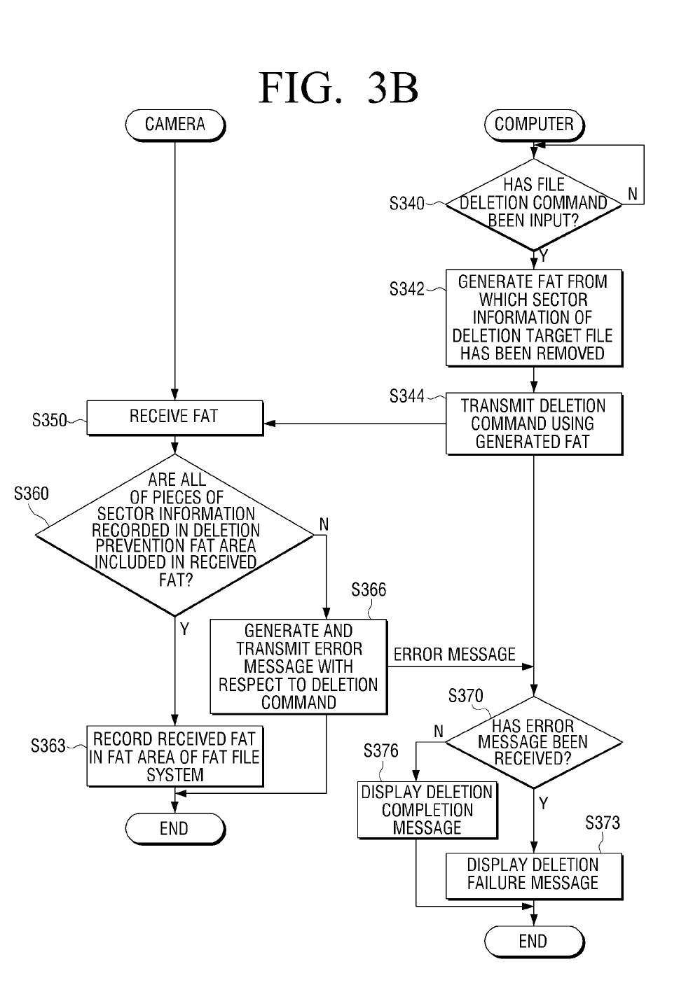

A method of preventing a deletion of a file using a FAT type deletion prevention area will now be described with reference to FIGS. 3A and 3B. FIG. 3A is a flowchart illustrating a method of setting deletion prevention with respect to a specific file using a FAT, according to an exemplary embodiment.

Referring to FIG. 3A, the camera 100 selects a file for which deletion prevention is to be set (S310). The camera 100 determines whether a deletion prevention setting command has been input with respect to the selected file (S320). If it is determined that the deletion prevention setting command has been input with respect to the selected file (S320—Y), the camera 100 records sector information about the selected file in a deletion prevention FAT area. For example, a deletion prevention FAT area is set as shown in FIG. 6A to set deletion prevention with respect to file “bbb.jpg” of files shown in FIG. 5B. A deletion prevention FAT area is set as shown in FIG. 6B to set deletion prevention with respect to file “aaa.jpg” of the files shown in FIG. 5B.

As described above, the camera 100 sets a deletion prevention area as a FAT area type.

FIG. 3B is a flowchart illustrating a process of preventing a deletion of a file for which deletion prevention has been set, using a FAT, according to an exemplary embodiment.

The computer 200 checks whether a file deletion command has been input from a user. If the file deletion command has been input from the user (S340—Y), the computer 200 generates a FAT from which sector information of a deletion target file has been removed (S342). The computer 200 transmits the file deletion command using the generated FAT to the camera 100 (S344).

The camera 100 receives the file deletion command and the FAT from which the sector information of the deletion target file has been removed (S350). The camera 100 determines whether all of pieces of sector information recorded in a deletion prevention FAT area are included in the received FAT (S360).

If all of the pieces of sector information recorded in the deletion prevention FAT area are included in the received FAT (S360—Y), the camera 100 records the received FAT in a FAT area of a FAT file system (S363). In other words, since a file for which deletion prevention has not been set is deleted, the camera 100 executes the file deletion command with respect to the deletion target file.

If at least one of the pieces of sector information recorded in the deletion prevention FAT area is not included in the received FAT (S360—N), the camera 100 does not execute the file deletion command. Instead, the camera 100 generates an error message about the file deletion command and transmits the error message to the computer 200 (S366). Since this case corresponds to a case where a deletion command is input with respect to a deletion-prevented file, the camera 100 does not execute the deletion command with respect to the deletion-prevented file.

The computer 200 determines whether the error message has been received (S370). If the error message has been received (5370—Y), the computer 200 displays a deletion failure message (S373). If the error message has not been received (S370—N), the computer 200 displays a deletion completion message (S376).

Through this process, the camera 100 sets deletion prevention with respect to a file using a FAT type deletion prevention area to prevent the file from being deleted by the computer 200.

In addition, it is possible that the file deletion command can be input from a key on the camera 100 or an icon displayed on a display of the camera 100. Upon selection of the key, button, or icon, the above-described process may be performed in the same way as when the camera receives the file deletion command from an external computer.

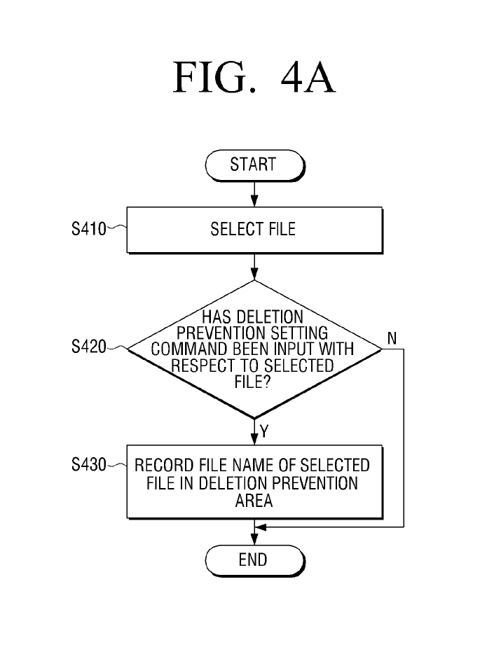

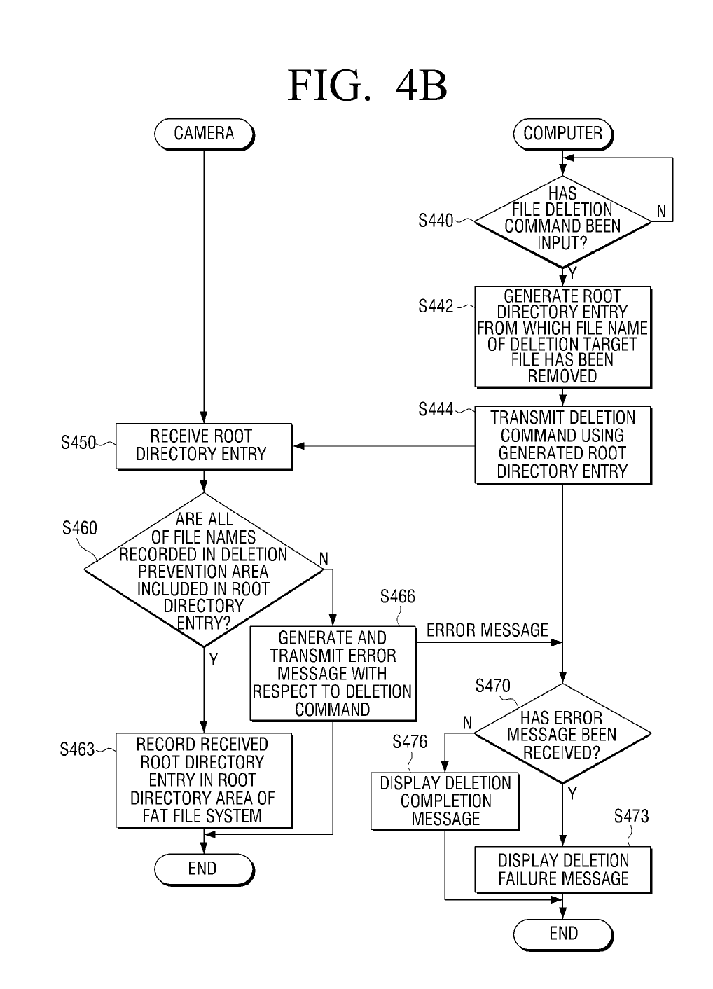

A method of preventing a deletion of a file using a root file directory type deletion prevention area will now be described in detail with reference to FIGS. 4A and 4B. FIG. 4A is a flowchart illustrating a method of setting deletion prevention with respect to a specific file using a file directory type deletion prevention area according to an exemplary embodiment.

Referring to FIG. 4A, the camera 100 selects a file for which deletion prevention is to be set (S410). The camera 100 determines whether a deletion prevention setting command has been input with respect to the selected file (S420). If the deletion prevention setting command has been input with respect to the selected file (5420—Y), the camera 100 records file name information about the selected file in a deletion prevention area (S430). For example, a root directory type deletion prevention area is set as shown in FIG. 7A to set deletion prevention with respect to file “bbb.jpg” of files shown in FIG. 5B. A root directory type deletion prevention area is set as shown in FIG. 7B to set deletion prevention with respect to file “aaa.jpg” of the files shown in FIG. 5B. The detailed contents of these will be described later.

As described above, the camera 100 sets a deletion prevention area as a root directory area type.

FIG. 4B is a flowchart illustrating a process of preventing a deletion of a file for which deletion prevention has been set, using a root directory type deletion prevention area, according to an exemplary embodiment.

Referring to FIG. 4B, the computer 200 checks whether a file deletion command has been received from a user (S440). If the file deletion command has been received from the user (S440—Y), the computer 200 generates a root directory entry from which file name information about a deletion target file has been removed (S442). The computer 200 transmits the file deletion command using the generated root directory entry to the camera 100 (S444).

The camera 100 receives the file deletion command and the root directory entry from which the file name information about the deletion target file has been removed (S450). The camera 100 determines whether all of pieces of file name information recorded in a deletion prevention area are included in the received root directory entry (S460).

If all of the pieces of file name information recorded in the deletion prevention area are included in the received root directory entry (S460—Y), the camera 100 records the received root directory entry in a root directory area of a FAT file system (S463). In other words, since a file for which deletion prevention has not been set is deleted, the camera 100 executes the file deletion command with respect to the deletion target file.

If at least one of the pieces of file name information recorded in the deletion prevention area is not included in the received root directory entry (S460—N), the camera 100 does not execute the file deletion command. Instead, the camera 100 generates an error message about the file deletion command and transmits the error message to the computer 200 (S466). Since a deletion command is input with respect to a deletion-prevented file, the camera 100 does not execute a deletion command with respect to a deletion-prevented file.

The computer 200 determines whether the error message has been received (S470). If the error message has been received (5470—Y), the computer 200 displays a deletion failure message (S473). If the error message has not been received (S470—N), the computer 200 displays a deletion completion message (S476).

Through this process, the camera 100 sets deletion prevention with respect to a file using a root directory type deletion prevention area to prevent the file from being deleted by the computer 200.

A structure of a FAT file system will now be described with reference to FIGS. 5A through 5C. FIG. 5A is a view illustrating a structure of a FAT file system according to an exemplary embodiment.

Referring to FIG. 5A, the FAT file system includes a volume ID 510, a reserved area 520, a first FAT area 530, a second FAT area 540, a root directory area 550, and a data area 560. A deletion prevention area 500 is included in a part of the data area 560. Descriptions of detailed functions of the above areas are generally known and thus will be omitted.

In general, a FAT area includes the first and second FAT areas 530 and 540, and the first FAT area 530 is mainly used or is used more frequently than the second FAT area 540. Therefore, in the present specification, a FAT area of a FAT file system will be referred to as the first FAT area 530.

A file name and an address of a start sector recorded in the data area 560 are recorded in the root directory area 550. Here, a sector corresponds to a unit of writing performed with respect to the data area 560. In other words, one file is recorded in at least one sector. If a file has a large size, the file is recorded in a plurality of sectors.

An example of the root directory area 550 is shown in FIG. 5B. FIG. 5B is a view illustrating a structure of the root directory area 550, according to an exemplary embodiment.

Information about files “aaa.jpg” and “bbb.jpg” is recorded in the root directory area 550 of FIG. 5B. In more detail, file “aaa.jpg” is recorded in a first area 551 of the root directory area 550, and an address “0x02” of a first sector recording the file “aaa.jpg” is recorded in a second area 552 of the root directory area 550. File “bbb.jpg” is recorded in a third area 555 of the root directory area 550, and an address “0x06” of a first sector recording the file “bbb.jpg” is recorded in a fourth area 556. In other words, in the root directory area 500, the first sector of the file “aaa.jpg” is recorded in the address “0x02,” and the first sector of the file “bbb.jpg” is recorded in the address “0x06.”

The first FAT area 530 refers to an area in which addresses of sectors after a second sector are recorded, i.e., addresses of all sectors of the data area 560 are recorded. An example of the first FAT area 530 is shown in FIG. 5C. FIG. 5C is a view illustrating a structure of the first FAT area 530, according to an exemplary embodiment.

Referring to FIG. 5B, an address of a first sector of file “aaa.jpg” is “0x02.” Therefore, a value of an area 531 corresponding to the address “0x02” is checked in the first FAT area 530 of FIG. 5C to check a next sector of the file “aaa.jpg.” As shown in FIG. 5C, since the value of the area 531 corresponding to the address “0x02” is “'0x04,” an address of the next sector of the file “aaa.jpg” is “0x04.” Also, since a value of an area 532 corresponding to the address “0x04” is “0x11,” an address of a next sector of the file “aaa.jpg” is “0x11.” Since a value of an area 533 corresponding to the address “0x11” is “0xFFFF,” the address“Ox11” is a last sector of the file “aaa.jpg.”

Referring to FIGS. 5B and 5C, addresses of sectors in which file “bbb.jpg” is recorded are sectors of a data area having addresses “0x06” and “0x13” in areas denoted by reference numerals 556, 535, and 536.

Files are recorded in a FAT file system according to the above-described method.

A structure of a FAT type copy prevention area (or a FAT type deletion prevention area) will now be described with reference to FIGS. 6A and 6B. FIG. 6A is a view illustrating a copy prevention area 500 in which copy prevention is set with respect to file “bbb.jpg”, according to an exemplary embodiment.

Sectors of areas 505 and 506 are recorded in the copy prevention area 500 of FAT type shown in FIG. 6A. The areas 505 and 506 of FIG. 6A respectively correspond to the areas 535 and 536 of FIG. 5C and indicate the file “bbb.jpg.”

Therefore, the file “bbb.jpg” is set as a copy-prevented file in the copy prevention area 500 of FAT type shown in FIG. 6A.

FIG. 6B is a view illustrating a copy prevention area 500 in which copy prevention is set with respect to file “aaa.jpg,” according to an exemplary embodiment.

Sectors of areas 501, 502, and 503 are recorded in the copy prevention area 500 of FAT type shown in FIG. 6B. The areas 501, 502, and 503 of FIG. 6B respectively correspond to the areas 531, 532, and 533 of FIG. 5C and indicate the file “aaa.jpg.”

Therefore, the file “aaa.jpg” is set as a copy-prevented file in the copy prevention area 500 of FAT type shown in FIG. 6B.

As described above, the camera 100 sets a copy-prevented file using the copy prevention area 500 of FAT type.

A structure of a root directory type copy prevention area will now be described with reference to FIGS. 7A and 7B. FIG. 7A is a view illustrating a copy prevention area 500 of root directory type in which copy prevention is set with respect to file “bbb.jpg,” according to an exemplary embodiment.

A file name and a start sector address of the file “bbb.jpg” are recorded in the copy prevention area 500 of root directory type shown in FIG. 7A. Therefore, the file “bbb.jpg” is set as a copy-prevented file in the copy prevention area 500 of root directory type shown in FIG. 7A.

FIG. 7B is a view illustrating a copy prevention area 500 of root directory type in which copy prevention is set with respect to file “aaa.jpg,” according to an exemplary embodiment.

A file name and a start sector address of the file “aaa.jpg” are recorded in the copy prevention area 500 of root directory type shown in FIG. 7B. Therefore, the file “aaa.jpg” is set as a copy-prevented file in the copy prevention area 500 of root directory type shown in FIG. 7B.

As described above, the camera 100 sets a copy-prevented file using the copy prevention area 500 of root directory type.

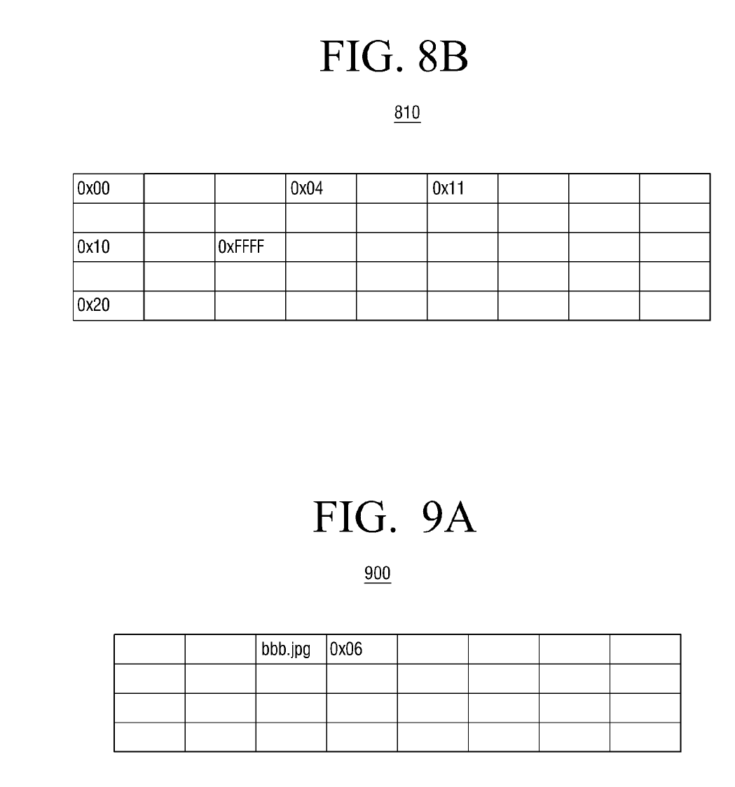

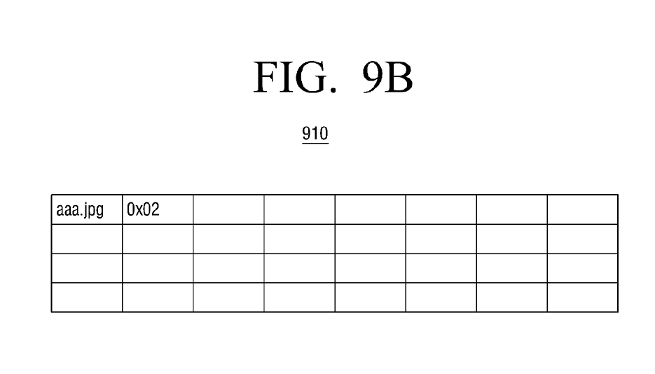

Structures of a root directory entry and a FAT generated to delete a file will now be described with reference to FIGS. 8A through 9B. FIG. 8A is a view illustrating a FAT generated by the computer 200 to delete file “aaa.jpg,” according to an exemplary embodiment. FIG. 9A is a view illustrating a root directory entry generated by the computer 200 to delete file “aaa.jpg,” according to an exemplary embodiment.

If files stored in the camera 100 are “aaa.jpg” and “bbb.jpg” as shown in FIGS. 5B and 5C, and a deletion command is input with respect to the file “aaa.jpg,” the computer 200 generates a FAT 800 from which pieces of sector information of the file “aaa.jpg” have been removed, as shown in FIG. 8A. The computer 200 generates a root directory entry 900 from which a file name and a start sector address of the file “aaa.jpg” have been removed, as shown in FIG. 9A.

If the computer overwrites the FAT 800 and the root directory entry 900 in the first FAT area 530 of the camera 100, the file “aaa.jpg” is deleted from the storage unit 140 of the camera 100.

By using the above-described method, the camera 100 deletes file “aaa.jpg” according to a command of the computer 200.

FIG. 8B is a view illustrating a FAT generated by the computer 200 to delete file “bbb.jpg,” according to an exemplary embodiment. FIG. 9B is a view illustrating a root directory entry generated by the computer 200 to delete file “bbb.jpg,” according to an exemplary embodiment.

If files stored in the camera 100 are “aaa.jpg” and “bbb.jpg” as shown in FIGS. 5B and 5C, and a deletion command is input with respect to the file “bbb.jpg,” the computer 200 generates a FAT 810 from which pieces of sector information of the file “bbb.jpg” have been removed, as shown in FIG. 8B. The computer 200 also generates a root directory entry 910 from which a file name and a start sector address of the file “bbb.jpg” have been removed, as shown in FIG. 9B.

If the computer 200 overwrites the FAT 810 and the root directory entry 910 in the first FAT area 530 of the camera 100, the file “bbb.jpg” is deleted from the storage unit 140 of the camera 100.

As described above, the computer 200 generates and overwrites a FAT and a root directory entry from which a deletion target file has been removed in order to execute a file deletion command. Therefore, the computer 200 may apply a copy preventing method (or a deletion preventing method) according to the present exemplary embodiment.

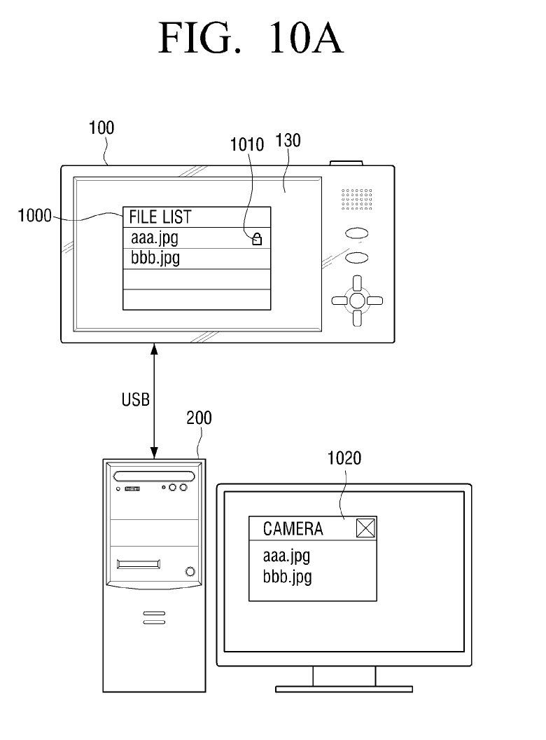

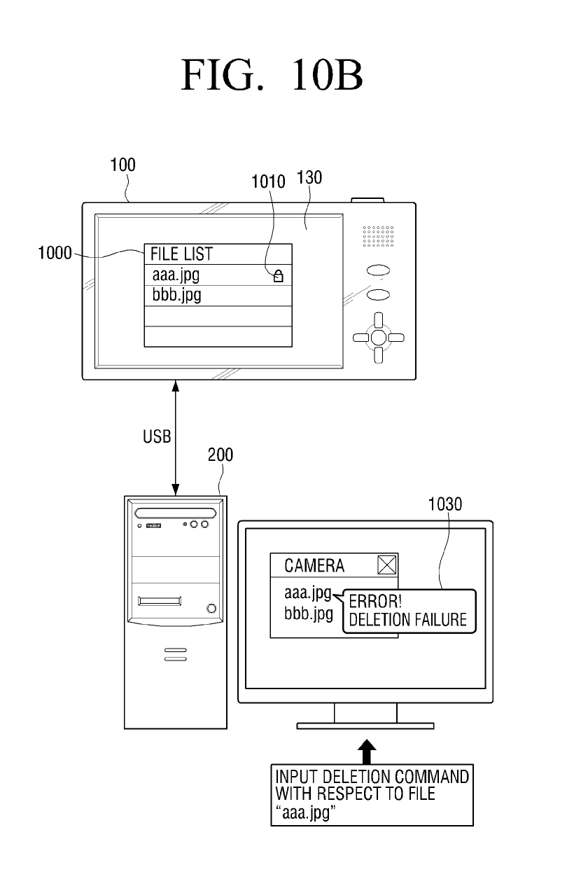

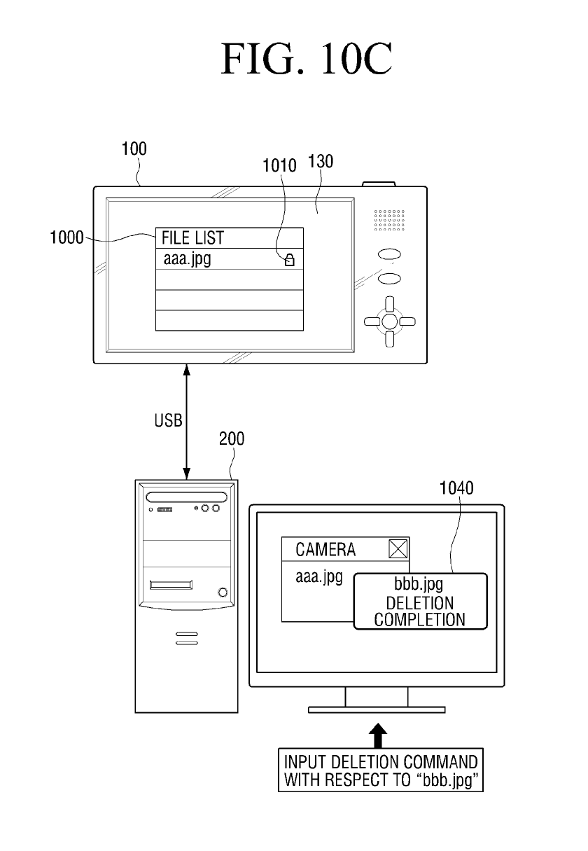

A process of performing deletion prevention will now be described with reference to FIGS. 10A through 100. FIG. 10A is a view illustrating a state of file “aaa.jpg” for which deletion prevention has been set, according to an exemplary embodiment.

As shown in FIG. 10A, a file list 1000 is displayed on the display unit 130 of the camera 100. The file list 1000 includes files “aaa.jpg” and “bbb.jpg,” and a deletion prevention mark 1010 is provided with respect to the file “aaa.jpg file.” In other words, deletion prevention is set with respect to the file “aaa.jpg.” Therefore, a deletion prevention area of the camera 100 is set as a type shown in FIG. 6B or 7B.

In this state, the camera 100 is connected to the computer 200 through a USB in FIG. 10A. Therefore, the computer 200 recognizes files stored in the camera 100 using a UMS. Accordingly, a file list 1020 stored in the camera 100 is displayed on a monitor of the computer 200.

FIG. 10B is a view illustrating a case where a deletion command is input with respect to file “aaa.jpg,” according to an exemplary embodiment. As shown in FIG. 10B, if a user inputs a deletion command with respect to the file “aaa.jpg,” the computer 200 generates the FAT 800 of FIG. 8A and the root directory entry 900 of FIG. 9A and transmits the FAT 800 and the root directory entry 900 to the camera 100.

The camera 100 compares the deletion prevention area 500 of FIG. 6B or 7B with one of the FAT 800 and the root directory entry 900. However, since deletion prevention is set with respect to the file “aaa.jpg” in FIGS. 6B and 7B, the camera 100 does not execute the deletion command with respect to the file “aaa.jpg,” generates an error message, and transmits the error message to the computer 200.

Therefore, a deletion failure message 1030 is displayed on the monitor of the computer 200, and the file “aaa.jpg” is not deleted.

FIG. 100 is a view illustrating a case where a deletion command is input with respect to file “bbb.jpg,” according to an exemplary embodiment.

As shown in FIG. 100, if the user inputs a deletion command with respect to the file “bbb.jpg,” the computer 200 generates the FAT 810 of FIG. 8B and the root directory entry 910 of FIG. 9B and transmits the FAT 810 and the root directory entry 910 to the camera 100.

The camera 100 compares the deletion prevention area 500 of FIG. 6B or 7B with one of the FAT 810 and the root directory entry 910. Since deletion prevention is set only with respect to the file “aaa.jpg file” in FIGS. 6B and 7B, the camera 100 executes the deletion command with respect to the file “bbb.jpg.”

Therefore, a deletion completion message 1040 is displayed on the monitor of the computer 200, and the file “bbb.jpg” is deleted.

As described above, the camera 100 includes an additional deletion prevention area to set deletion prevention with respect to a specific file. Since the deletion prevention area has a root directory type or a FAT type, the camera 100 maintains a deletion prevention function although a deletion command is input from the computer 200.

The computer 200 does not use a specific program provided by an electronic device manufacturer of a camera or the like but uses a general program using a UMS. Therefore, deletion prevention according to the present exemplary embodiment may have a wide range of applications.

In the present exemplary embodiment, an electronic device has been described as the camera 100 but may be any device which stores files using a FAT file system. For example, the electronic device may be a cellular phone, a portable multimedia player (PMP), an MPEG Audio Layer-3 (MP3), or the like.

Although various example embodiments of the present general inventive concept have been illustrated and described, it will be appreciated by those skilled in the art that changes may be made in these example embodiments without departing from the principles and spirit of the general inventive concept, the scope of which is defined in the appended claims and their equivalents.

What is claimed is:

1. An electronic device, comprising:
an interface unit to be connected to a computer;
a storage unit to store files using a file allocation table (FAT) file system comprising a deletion prevention area; and
a controller to determine whether a file stored in the storage unit is to be deleted by using the deletion prevention area if a deletion command is input via the computer with respect to the file stored in the storage unit.

2. The electronic device as claimed in claim 1, wherein the deletion prevention area is an additional deletion prevention FAT area.

3. The electronic device as claimed in claim 2, wherein sector information, which is a deletion prevention target, is recorded in the additional deletion prevention FAT area.

4. The electronic device as claimed in claim 3, wherein if a deletion command is input via the computer with respect to the file stored on the storage unit, the controller receives a FAT from the computer from which pieces of sector information of a deletion target file have been removed.

5. The electronic device as claimed in claim 4, wherein the controller does not execute the deletion command if at least one of the pieces of sector information recorded in the additional deletion prevention FAT area is not comprised in the received FAT.

6. The electronic device as claimed in claim 4, wherein if all of the pieces of sector information recorded in the additional deletion prevention FAT area are comprised in the received FAT, the controller records the received FAT in a FAT area of the FAT file system to execute the deletion command.

7. The electronic device as claimed in claim 1, wherein the deletion prevention area is an additional root directory area.

8. The electronic device as claimed in claim 7, wherein a file name corresponding to a deletion prevention target is recorded in the deletion prevention area.

9. The electronic device as claimed in claim 8, wherein if the deletion command is input via the computer with respect to the file stored on the storage unit , the controller receives from the computer a root directory entry from which a file name of a deletion target file has been removed.

10. The electronic device as claimed in claim 9, wherein if at least one of file names recorded in the deletion prevention area is not comprised in the received root directory entry, the controller does not execute the deletion command.

11. The electronic device as claimed in claim 9, wherein if all of the file names recorded in the deletion prevention area are comprised in the received root directory entry, the controller records the received root directory entry in a root directory area of the FAT file system to execute the deletion command.

12. A method of preventing a deletion of a file of an electronic device connected to a computer, the method comprising:
connecting the electronic device to the computer through an interface;
storing files using a FAT file system comprising a deletion prevention area; and
determining whether a file stored in the electronic device is to be deleted if a deletion command is input via the computer.

13. The method as claimed in claim 12, wherein the deletion prevention area is an additional deletion prevention FAT area.

14. The method as claimed in claim 13, wherein sector information corresponding to a deletion prevention target is recorded in the additional deletion prevention FAT area.

15. The method as claimed in claim 14, wherein the determination as to whether the corresponding file is to be deleted comprises receiving from the computer a FAT from which pieces of sector information of a deletion target file have been removed if a deletion command is input from the computer with respect to the file.

16. The method as claimed in claim 15, wherein the determination comprises determining to not execute the deletion command if at least one of the pieces of sector information recorded in the additional deletion prevention FAT area is not comprised in the received FAT.

17. The method as claimed in claim 15, wherein the determination comprises recording the received FAT in a FAT area of the FAT file system to execute the deletion command if all of the pieces of sector information recorded in the additional deletion prevention FAT area are comprised in the received FAT.

18. The method as claimed in claim 12, wherein the deletion prevention area is an additional root directory area.

19. The method as claimed in claim 18, wherein a file name corresponding to a deletion prevention target is recorded in the deletion prevention area.

20. The method as claimed in claim 19, wherein the determination comprises receiving from a computer a root directory entry from which a file name of a deletion target file has been removed if a deletion command is input with respect to at least one of the stored files through the computer.

21. The method as claimed in claim 20, wherein the determination comprises determining to not execute the deletion command if at least one of file names recorded in the deletion prevention area is not comprised in the received root directory entry.

22. The method as claimed in claim 20, wherein the determination comprises recording the received root directory entry in a root directory area of the FAT file system to execute the deletion command if all of the file names recorded in the deletion prevention area are comprised in the received root directory entry.
